(19) United States
(12) Patent Application Publication
(10) Pub. No.: US 2005/0103646 A1
(43) Pub. Date: May 19, 2005

(54) Method of determining active catalyst material in suspensions

(75) Inventor: Matthias Boll, Koln (DE)

Correspondence Address: Norris, McLaughlin & Marcus P.A., 18th Floor, 875 Third Avenue, New York, NY, 10022, US

(73) Assignee: Bayer Technology Sevices GmbH, Leverkusen (DE)

(21) Appl. No.: 10/958,795

(22) Filed: Oct. 5, 2004

(30) Foreign Application Priority Data
Oct. 29, 2003 (DE) 10350524.5

(51) Int. Cl. G01N 27/26

(52) U.S. Cl. 205/789; 205/793.5

(57) ABSTRACT

A method for determining the concentration of catalyst material in suspension in a hydrogenation reaction mixture on-line by determining the potential difference between a measuring electrode which dips into the reaction mixture and a reference electrode.

The invention relates to a method of determining the relative concentration of hydrogenation-active catalyst material and catalyst material saturated with hydrogen in catalyst suspensions on-line.

### BACKGROUND OF THE INVENTION

In liquid-phase hydrogenation using Raney nickel catalysts, attempts have been made to control the introduction of a nitroaromatic during the hydrogenation by monitoring the potential difference between a reference electrode and the catalyst (with contact via a measuring or working electrode) (cf. G. Alscher et al, Chem. Technik 48, (1996), 6, p. 323, and H. Ehwald et al, Verfahrenstechnik 32 (1998), 142, p. 41). However, use of this technique for monitoring the Raney nickel catalyst distribution in the hydrogenation reactor is not mentioned, nor is the quantification of the noise signal for determining the active, hydrogen-laden Raney nickel concentration. A very uniform distribution of Raney nickel catalyst, hydrogen and starting material to be hydrogenated in a hydrogenation reactor is the basic prerequisite for a hydrogenation reaction to proceed with high selectivity and in high yield. However, the concentration of the Raney nickel catalyst during the hydrogenation process is dependent on many parameters which make a purely theoretical (mathematical) treatment of such a problem very difficult. To distinguish dead volumes in which the catalyst concentration is comparatively low or in which deposits of Raney nickel catalysts have been formed from regions in the reactor in which there is a high flow rate of sufficiently active catalyst particles, it is necessary to develop an on-line measurement method for determining the active catalyst catalyst, for example to avoid possible oxidation of the nickel by excess starting material.

A further application is the rapid examination of the activity of hydrogenation catalysts, for example by manufacturers of hydrogenation catalysts. Quantification of the noise signal enables the concentration of active catalyst material in a fixed catalyst concentration to be determined. This value can, in addition to the absolute value of the potential difference, be used for monitoring the quality of the respective batch.

### SUMMARY OF THE INVENTION

To achieve this object, the invention provides a process for determining the concentration of active catalyst material in catalyst-containing suspensions of hydrogenation reaction mixtures on-line by determining the potential difference and/or the variation over time of this difference between a measuring electrode which is made of an inert material and dips into the constantly stirred reaction mixture and a reference electrode while hydrogen is passed continuously through the reaction mixture. The potential difference is then converted to concentration by reference to a calibration obtained using known active catalyst suspensions.

### DETAILED DESCRIPTION

Preference is given to a method in which the measured absolute voltage or a time-average value of the voltage over at least 1 minute, preferably at least 2 minutes, if applicable after a concentration change of the catalyst in the mixture is used as measure of the potential difference between reference electrode and measuring electrode.

Preference is also given to using the standard deviation of an absolute voltage measured over a period of time, in particular of at least 30 seconds, as measure.

Preference is also given to a method in which the pH of the reaction mixture is kept constant during the measurement, in particular by use of a buffer solution.

In a particularly preferred embodiment, the temperature and/or the pressure in the reaction mixture is additionally kept constant. This leads to substantial reduction or elimination of measurement fluctuations.

The method is especially useful for measuring the concentration of Raney nickel, platinum, palladium or nickel catalysts in each case on carbon or silicon oxide as support material, particularly preferably of Raney nickel or platinum on carbon.

The general method of measuring electrochemical potentials on, for example, gold or platinum output electrodes or on output electrodes made of other materials is generally known and is employed widely (cf., for example, J. Pardillos-Guindet, J. of Catalysis 155, (1995), pp. 12-20 or U. Kürschner et al, Catalysis Letters 34, (1995), pages 191-199).

The reference electrode is usually connected in an electrically conductive fashion, i.e. in an ion-conducting fashion with the reactor solution and is particularly preferably located outside the reactor. The reference electrode should thus be at a temperature which is independent of the reaction temperature and provide a potential which is constant over time. An electrode of the second type is preferably used as reference electrode.

A particularly suitable material for the measuring electrode is an inert metal such as gold, since it is frequently the case that no further chemical processes which could influence the potential occur on this metal. The measuring electrode therefore particularly preferably consists of a chemically inert metal, in particular gold, preferably configured as a sheet, wire or mesh.

A particularly suitable material for the reference electrode has a timt independent and reproducible electrochemical potential, e.g. “Argental” (Ag/AgCl) or “Kalomel” (Hg/Hg₂Cl₂) electrodes.

The invention further provides a method of carrying out hydrogenation reactions in solution using a hydrogenation catalyst suspended in the reaction mixture, the method of the invention for determining the catalyst concentration is used for monitoring the active catalyst concentration.

For the purposes of the invention, an active catalyst is either a catalyst which is catalytically active in respect of the hydrogenation or a catalyst which is sufficiently laden with hydrogen. It is also possible and preferable to modify the process so that the loading of the catalyst with hydrogen is monitored at a constant catalyst concentration.

The method of the invention makes the following advantages possible:

Firstly, the operating life of the catalyst can be increased, in particular in the case of Raney nickel catalysts, by lengthening the shelf life. Furthermore, the method is used for quality assurance in the production of catalyst material, in particular Raney nickel catalysts, or for quality assurance in respect of the course of the reaction in hydrogenation reactions.

The invention also provides a method of determining the quality of hydrogenation catalysts in a buffered solution, wherein the above-described method of the invention is used for determining the relative concentration of active catalyst particles in a catalyst suspension, based on the total amount of catalyst particles, with the variation over time of the potential difference being measured and the concentration being determined by means of calibration using known active catalyst suspensions.

The invention is illustrated below by way of example with the aid of the figures.

### BRIEF DESCRIPTION OF THE DRAWINGS

In the figures:

FIG. 1 shows a voltage-time graph for the addition of catalyst suspension

FIG. 2 shows the standard deviation of the voltage from a mean value over time

FIG. 3 shows the potential as a function of time for activated and deactivated catalyst.

### EXAMPLES

The potential difference between the gold electrode dipping into a simulated reaction solution and a calomel electrode (reference electrode) connected with the solution via a salt bridge was measured.

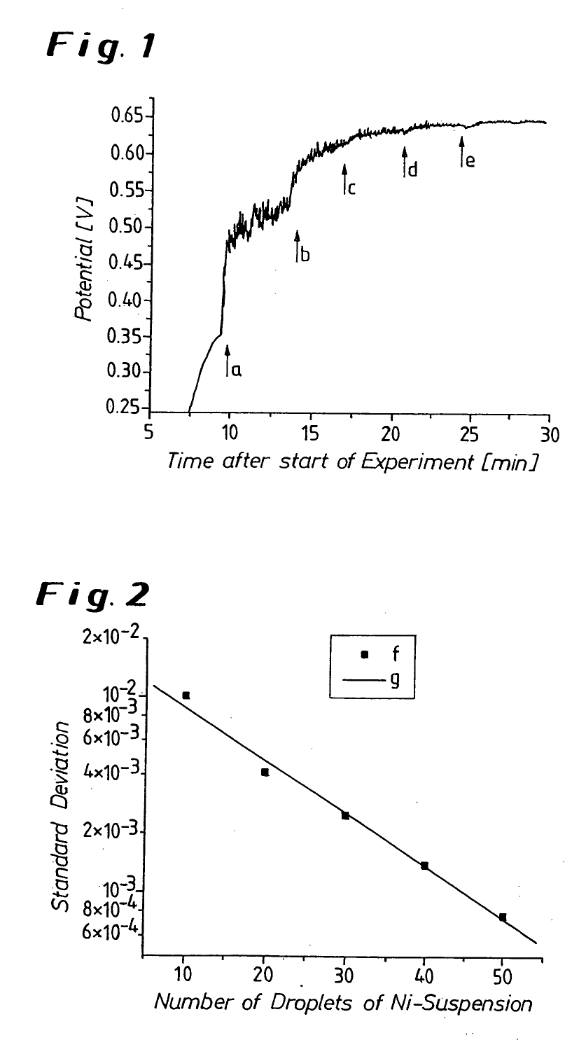

FIG. 1 shows the absolute voltage as a function of the addition of fresh Raney nickel catalyst solution as a suspension to a buffer solution of 0.3 normal K₂HPO₄/NaH₂PO₄ buffer solution. The solution was stirred at a stirrer speed of 400 rpm and hydrogen was passed through the solution in an amount of 10 ml/min. In FIG. 1, the points in time a) to e) at which in each case 10 drops of a defined Raney nickel catalyst suspension were added are marked. The stepwise increase in the absolute voltage, in particular during the initial addition, can clearly be seen, and it is also possible to see the change in the noise width (change in the standard deviation) from addition to addition.

In FIG. 2, the standard deviation of the measured voltage of a mean value over time is plotted as a function of the amount of nickel suspension. It is immediately possible to see the correlation between standard deviation and Raney nickel catalyst concentration.

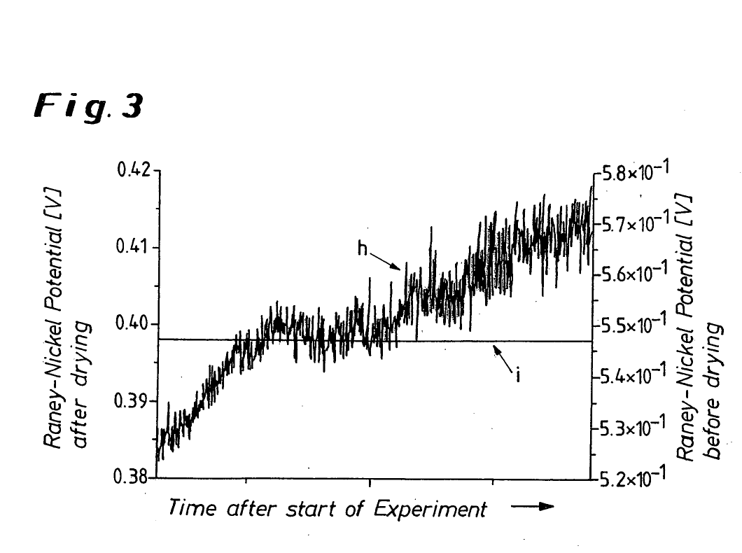

FIG. 3 once more shows for comparison the potential versus time for a deactivated Raney nickel catalyst (h) and the potential of an activated hydrogenation catalyst comprising Raney nickel as line (i). This demonstrates that active and deactivated catalyst can be distinguished unambiguously.

1. A Method for determining the concentration of catalyst material in suspensions in hydrogenation reaction mixtures which comprises determining a potential difference, and the variation over time of this difference, between a measuring electrode which in contact with the reaction mixture and a reference electrode.

2. Method according to claim 1, wherein the measured absolute voltage or a time-average value of the voltage over a period of at least 1 minute after a concentration change of the catalyst in the mixture is used as measure of the potential difference.

3. Method according to claim 2, wherein said period is at least 2 minutes.

4. Method according to claim 1, wherein the standard deviation of the absolute voltage measured over a period of time of at least 30 seconds is used as measure of catalyst concentration.

5. Method according to claim 1, wherein the pH of the reaction mixture is kept constant during the measurement.

6. Method according to claim 5, wherein said pH is kept constant by a buffer solution.

7. Method according to claim 1, wherein the temperature or the pressure, or both the temperature and the pressure, in the reaction mixture is/are kept constant.

8. Method according to claim 1, wherein said catalyst material is selected from the group consisting of Raney nickel, finely divided platinum, palladium and nickel, on carbon or silicon oxide as support material.

9. Method according to claim 8, wherein said catalyst material is Raney nickel on a carbon support or platinum on a carbon support.

10. Method according to claim 1, wherein said reference electrode is in ion-conducting connection with the reaction solution and is located outside the reactor and provides a potential which is constant over time.

11. Method according to claim 7, wherein the reference electrode is an electrode of the second type.

12. Method according to claim 1, wherein the measuring electrode is comprised of a chemically inert metal.

13. Method according to claim 12, wherein said chemically inert metal is gold.

14. Method according to claim 12, wherein the measuring electrode is in the form of a sheet, mesh or wire.

15. Method of carrying out hydrogenation reactions in solution using a hydrogenation catalyst suspended in the reaction mixture, active catalyst concentrations are determined by the method of claim 1, and said concentrations are monitored.

16. Method of determining the quality of hydrogenation catalysts in a buffered solution, wherein the relative concentration of active catalyst particles in a catalyst suspension, based on the total amount of the catalyst particles, is determined according to the method of claim 1, with the variation over time of the potential difference being measured and the concentration being determined with reference to a calibration prepared from measurements made with known active catalyst suspensions.
